(19) United States
(12) Patent Application Publication
(10) Pub. No.: US 2026/0086375 A1
(43) Pub. Date: Mar. 26, 2026

(54) WEARABLE DISPLAY DEVICE

(71) Applicant: Apple Inc., Cupertino, CA (US)

(72) Inventors: Alison B Shutzberg, San Francisco, CA (US); Christopher Patton, San Jose, CA (US); Nawaf Al-Baghly, San Jose, CA (US); Andrew N Leopold, San Francisco, CA (US)

(21) Appl. No.: 19/078,548

(22) Filed: Mar. 13, 2025

Related U.S. Application Data
(60) Provisional application No. 63/696,861, filed on Sep. 20, 2024.

(51) Int. Cl. G02B 27/01

(52) U.S. Cl. CPC G02B 27/0176; G02B 2027/0138; G02B 2027/0163

(57) ABSTRACT

A wearable display device can include a frame, one or more securement arms, transparent windows secured to the housing, a slot defined by the frame, and an electronic sub-assembly disposed within the slot of the frame. The electronic sub-assembly is enclosed within the slot of the frame by an epoxy or a cap.

### CROSS-REFERENCE TO RELATED APPLICATIONS

This claims priority to U.S. Provisional Patent Application No. 63/696,861 , filed 20 Sep. 2024, and entitled “WEARABLE DISPLAY DEVICE,” the entire disclosure of which is hereby incorporated by reference.

### FIELD

The present disclosure relates generally to electronic devices. More particularly, the present disclosure relates to wearable display devices.

### BACKGROUND

Recent advances in portable computing have enabled wearable display devices that provide augmented and virtual reality experiences to users. Various components of these devices, such as display screens, viewing frames, transparent windows, securement arms, projectors, waveguides, speakers, processors, controllers, memory components, batteries, and other components operate together to provide an immersive and comfortable experience to the user. Many of these operational components are electronically and/or physically connected and space within or on wearable devices is limited. It is a challenge to arrange all the components in a way that does not jeopardize the user experience and comfort.

### SUMMARY

In at least one example, a wearable display device can include a frame defining a first opening and a second opening, one or more securement arms, a first transparent window disposed within the first opening and a second transparent window disposed within the second opening, a slot defined by the frame that extends along the frame with an opening that is directed toward the first opening or the second opening, and an electronic sub-assembly disposed within the slot of the frame. The electronic sub-assembly is enclosed within the slot and the slot is sealed closed.

In one example, an epoxy encloses the electronic sub-assembly within the slot of the frame. In one example, the epoxy defines a groove that is configured to receive the first transparent window and the second transparent window. In one example, a cap encloses the electronic sub-assembly within the slot of the frame. In one example, the cap defines a groove that is configured to receive the first transparent window and the second transparent window. In one example, the slot extends into a bridge of the frame disposed between the first transparent window and the second transparent window. In one example, the electronic sub-assembly extends in the slot from a first lateral end of the frame through the bridge and to a second lateral end of the frame. In one example, the sub-assembly extends in the slot downward from the bridge adjacent to the first opening and the sub-assembly extends in the slot downward from the bridge adjacent to the second opening. In one example, the bridge defines an opening on a lower portion of the bridge and the opening on the lower portion of the bridge is sealed with a charging contact. In one example, the sub-assembly includes a controller that is electronically coupled with various electronic components and each electronic component is electronically coupled to the controller by a wire. In one example, the various electronic components can include a first outward-facing camera disposed in a first temple region, a second outward-facing camera disposed in a second temple region, a first inward camera disposed adjacent to the first opening and a bridge, the bridge being disposed between the first opening and the second opening, and a second inward camera disposed adjacent to the second opening and the bridge.

In at least one example, a front frame of a wearable display device can include a first hoop defining a first opening, a second hoop defining a second opening, a first transparent window secured in the first opening, a second transparent window secured in the second opening. The first hoop defines a first slot that extends along a portion of the first opening and the second hoop defines a second slot that extends along a portion of the second opening. The front frame can further include an electronic sub-assembly that is sealed within the first slot and the second slot.

In one example, the front frame can further include a bridge disposed between the first hoop and the second hoop, the bridge connects the first slot to the second slot and the electronic sub-assembly is further sealed within the bridge. In one example, an epoxy is disposed around the electronic sub-assembly and seals openings of the first slot and the second slot. In one example, a cap is adhered to openings of the first slot and the second slot to enclose the electronic sub-assembly within the first slot and the second slot. In one example, the sub-assembly includes a controller electronically coupled with various electronic components and each electronic component is electronically coupled to the controller by a wire. In one example, the wire is adhered to an internal surface of both the first slot and the second slot. In one example, the first slot extends along an upper section of the first hoop and downward an inner section of the first hoop and the second slot extends along an upper section of the second hoop and downward an inner section of the second hoop.

In at least one example, a front frame for a wearable display device can include a frame defining a first opening and a second opening, a first transparent window disposed within the first opening and a second transparent window disposed within the second opening, and an electronic sub-assembly that interconnects electronic components by a wire and is entirely enclosed within the frame. A cross-section of the frame above the first opening and the second opening can include a first U-shaped portion defining a first cavity and a first cavity opening directed toward the first opening or the second opening, a first wire adhered to a surface of the U-shaped portion, and an epoxy that entirely encapsulates the wire within the first cavity and seals the first cavity opening. The epoxy defines a groove that is configured to engage with either the first transparent window or the second transparent window.

In one example, the front frame can further include a bridge that is at least partially disposed between the first opening and the second opening. A cross-section of the bridge can include a second U-shaped portion defining a second cavity and a second cavity opening, a controller disposed within the second cavity, and a charging contact of the controller disposed within the second cavity opening of the second U-shaped portion.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of a wearable display device;

FIG. 2 shows a side view of a wearable display device worn by a user;

FIG. 3 shows a front view of a wearable display device;

FIG. 4A shows a sub-assembly configured to be disposed within a body of a frame of a wearable display device;

FIG. 4B shows the sub-assembly of FIG. 4A being inserted into a bridge of the frame of the wearable display device;

FIG. 4C shows the sub-assembly of FIG. 4A being inserted into a brow and a hoop of the frame of the wearable display device;

FIG. 4D shows closing the sub-assembly of FIG. 4A within the frame of the wearable display device;

FIG. 5A shows one example of potting a portion of a sub-assembly within a hoop of a frame of a wearable display device;

FIG. 5B shows one example of enclosing a portion of a sub-assembly within a hoop of a frame of a wearable display device;

FIG. 5C shows on example of enclosing a portion of a sub-assembly with a bridge of a frame of a wearable display device;

FIG. 6A shows one example of potting a portion of a sub-assembly within an enclosed hoop of a frame of a wearable display device;

FIG. 6B shows one example of enclosing and potting a portion of a sub-assembly within a bridge of a frame of a wearable display device;

FIG. 7 shows an example of a sub-assembly of a wearable display device;

FIG. 8 shows an example of a sub-assembly of a wearable display device; and

FIG. 9 shows an example of a sub-assembly of a wearable display device.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The present disclosure relates to electronic devices. More particularly, the present disclosure relates to wearable devices, such as head-mountable electronic devices or wearable display devices. In at least one example, a wearable display device can include a frame and an electronic sub-assembly enclosed within the frame of the wearable display device. Components of the electronic sub-assembly can include projectors, waveguides, processors, controllers, memory components, speakers, batteries, and other components that operate together to provide an immersive and comfortable experience to the user. Examples of wearable display devices can include virtual reality or augmented reality devices that include an optical component. In the case of augmented reality devices, optical eyeglasses can be worn on the head of a user such that transparent windows, such as optical lenses and/or optical displays, are secured to the viewing frame and positioned in front of the user's eyes when the device is donned. In another example, a virtual reality device can be worn on the head of a user such that a display screen is positioned in front of the user's eyes. The viewing frame can include a housing or other structural component supporting or housing the optical component, for example lenses or screens.

In order to arrange the various operational components within a limited space provided by the lens or display frames and securement arms, the wearable display devices of the present disclosure can include frames having channels extending along various lengths of the frames within which the electronic assemblies can be disposed. The channels can be disposed along interior portions of the frames, for example portions of the frame facing a user's face when donned, such that seams and junctions of channels and frame portions are not visible to outside observers, thus providing a more aesthetically pleasing product.

In addition, the electronic subassemblies, including cables, wires, and circuitry components electronically connecting the various operational components noted above, can be placed at strategic locations within the various channels of the frames and encapsulating material can be filled in around the electronic components to seal off the channels and protect the components from exposure to the external environment. The encapsulating and sealing materials within the channels can also be strategically placed to affect heat dissipation and flow away from the user's face so the user does not come into contact with hotspots from heat generated by the internal operational component within the frame during use.

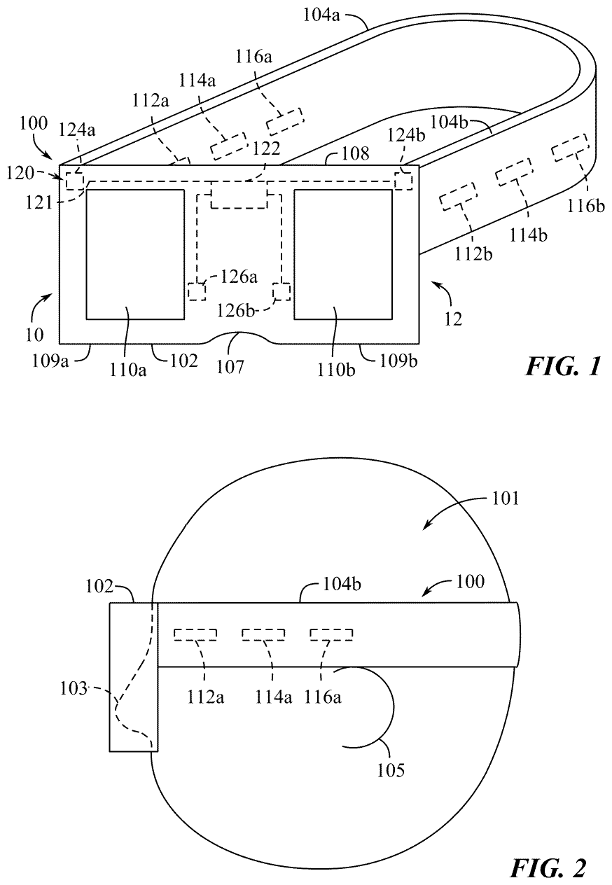

These and other examples are discussed below with reference to FIG. 1-9. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

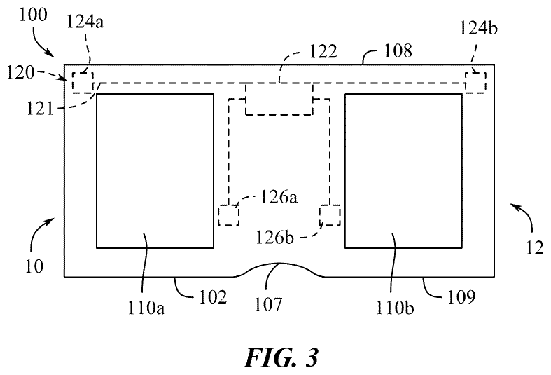

FIG. 1-3 show an example of a wearable display device 100. The wearable display device 100 can be any device or system configured to be worn on the head of a user, such as a head-mountable electronic device, an optical device, smart glasses, alternate/virtual reality goggles, or the like. Thus, the term “device” is used for the sake of convenience, without the intent to limit this term. FIG. 1 shows a perspective view of the wearable display device 100, FIG. 2 shows a side view of the wearable display device 100 worn on a user's head 101, and FIG. 3 shows a front view of the wearable display device 100.

The wearable display device 100 can include a frame 102 configured to secure one or more transparent windows 110 in front of the eyes of the user. In the illustrated example, the wearable display device 100 includes a pair of transparent windows 110a, 110b. The transparent windows 110a, 110b can be optical lenses or display screens. The transparent windows 110a, 110b can include an optically transparent material. The transparent windows 110a, 110b can include an optical lens. The transparent windows 110a, 110b can allow light to pass through without redirecting the light, or the transparent windows 110a, 110b can include vision correcting geometries. In at least one example, the frame 102 can include a bridge 107. The bridge 107 can be configured to extend across and/or rest on the user's nose 103.

The frame 102 of the wearable display device 100 can include a brow 108 that extends along an upper length of the frame 102 from a first lateral end 10, through the bridge 107, and to a second lateral end 12. The frame 102 can further define a first hoop 109a that extends around the first transparent window 110a and a second hoop 109b that extends around the second transparent window 110b. The first hoop 109a defines a first opening that receives the first transparent window 110a and the second hoop 109b defines a second opening that receives the second transparent window 110b. Portions of the hoops 109a, 109b can also include the brow 108.

The frame 102 of the wearable display device 100 can further include one or more securement arms 104a, 104b extending from the frame 102 distally towards a rear of the user's head 101. In the illustrated example, the one or more securement arms 104a, 104b includes a strap configured to extends around the user's head 101.

Each of the securement arms 104a, 104b can be secured to the frame 102 and can be configured to extend (e.g., distally) toward the rear of the user's head 101. The securement arms 104a, 104b can extend over the user's ears 105 and curve along (e.g., adjacent to) the user's head 101. The securement arms 104a, 104b can be configured to rest on the user's ears 105. The securement arms 104a, 104b can also be configured to apply opposing pressures to the sides of the user's head 101. Thus, the device 100 can be secured to the user's head 101 by a normal force applied from the user's nose 103 to the frame 102, normal forces applied from the user's ears 105 to the securement arms 104a, 104b, and friction forces between the frame 102 and the securement arms 104a, 104b and the user's head 101.

Each of the securement arms 104a, 104b can include one or more electronic components, such as electronic components 112a, 112b, electronic components 114a, 114b, and electronic components 116a, 116b illustrated in FIG. 1. The electronic components 112a, 112b, 114a, 114b, 116a, 116b can include any number of electronic components and can be configured to operate and produce a virtual or augmented reality experience to the user through the device 100. The first and second electronic components 112a, 112b, 114a, 114b can include at least one of a projector, a waveguide, a speaker, a processor, or a memory component and the third electronic components 116a, 116b can include a battery or any other component including those described with reference to the first and second electronic components 112a, 112b, 114a, 114b. In some examples, the third electronic component 116a, 116b can be a port for an external battery. In examples where the electronic component(s) 112a, 112b, 114a, 114b, 116a, 116b include a projector and/or a waveguide, the projector and/or waveguide can be configured to project light that is displayed on the transparent windows 110a, 110b secured to the frame 102. In some examples, the projectors and/or waveguides can be disposed on the brow 108 of the frame 102.

In examples where the third electronic components 116a, 116b includes a battery, the battery can be connected to the electronic components 112a, 112b, 114a, 114b via an electronic circuitry components 116a, 116b to deliver power to the electronic components 112a, 112b, 114a, 114b. In some examples, the electronic circuitry component 116a, 116b can include one or more electrically conductive wires, flexes, resistors, circuit boards, or any other electronic circuitry components connecting the third electronic component 116a, 116b to the first electronic component 112a, 112b and/or the second electronic component 114a, 114b. In some examples, the electronic circuitry component 116a, 116b can include an electrical cable or wire. In some examples, the electrical cable or wire can include a planar flex.

The electronic components 112a, 112b, the electronic components 114a, 114b, the electronic components 116a, 116b, and/or the electronic circuitry components 116a, 116b can be disposed within an internal volume of the device 100 (e.g., within an internal volume of the one or more securement arms 104a, 104b) such that the components are hidden from view.

Alternatively, one or more of the components 112a, 112b, 114a, 114b, 116a, 116b can be disposed on the wearable display device 100, such as on a housing of the securement arms 104a, 104b. The electronic component 112a, 112b and/or the electronic component 114a, 114b can be included in the frame 102, and an electronic circuitry component the same or similar to the electronic circuitry component 116a, 116b can be included between the frame 102 and the securement arms 104a, 104b to connect any of the electronic components 112a, 112b, 114a, 114b, 116a, 116b.

The frame 102 can include one or more electronic components housed within the frame 102. For example, the one more electronic components can include a sub-assembly 120 that interconnects a plurality of electronic components. The sub-assembly 120 can include a controller or microprocessor 122 disposed in the bridge 107 of the frame 102. The bridge 107 portion of the sub-assembly 120 can further include a charge circuit for charging a power source for the sub-assembly 120. The charge circuit can include a charging contact that engages with a charger. In some examples, the charging contact can engage with a charger disposed within a case of the wearable display device 100 for charging the sub-assembly 120. The power source for the sub-assembly can be disposed within the bridge 107, disposed within the one or more securement arms 104a, 104b, such as electronic component 116a, 116b, or an external power source.

The controller 122 can be electronically coupled via wires or a cable 121 to a first electronic component 124 and a second electronic component 126. Possible electronic components can include cameras, projectors, waveguides, microphones, processors, memory components, power sources, speakers, batteries, and the like. The sub-assembly 120 is not limited to two different electronic components, 124, 126, but can utilize a variety of different electronic components to provide an engaging experience to the user.

In some examples, the first electronic components 124a, 124b can be outward-facing cameras. For example, a first electronic component 124a disposed on a first lateral end 10 (e.g., a first temple region) can be a first camera and the second electronic component 124b disposed on a second lateral end 12 (e.g., a second temple region) can be a second camera. The first camera can be a narrow lens camera and the second camera can be a wide lens camera. In some examples, the first camera can be a wide lens camera and the second camera can be a narrow lens camera. In some examples, the first camera and the second camera can both include a wide lens camera and a narrow lens camera. Image data gathered from the outward-facing cameras can be transferred to the controller 122. In some examples, the first camera can include a separate controller located with the first camera that can communicate with the controller 122.

In some examples, the first electronic components 124a, 124b can include a projector or waveguide. The projector or waveguide can be configured to project light displayed on the transparent windows 110a, 110b.

In at least one example, the second electronic component 126a, 126b can be inward facing eye-tracking camera to track the user's eyes. The second electronic component 126a disposed on a first lateral end 10 can be a first eye-tracking camera and the second electronic component 126b disposed on a second lateral end 12 can be a second eye-tracking camera. The first eye-tracking camera can track one of the user's eyes and the second eye-tracking camera can track the other eye. The eye-tracking cameras can be used to track the eye position, gaze direction, and movement of the user's eyes and transfer related data to the controller 122, thus enabling the user to input information into, receive feedback from, and otherwise interact with the wearable display device 100 using eye movements. In at least one example, the second camera can include a separate controller located with the second camera that can communicate with the controller 122.

Any of the features, components, and/or parts, including the arrangements and configurations thereof shown in FIG. 1-3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1-3.

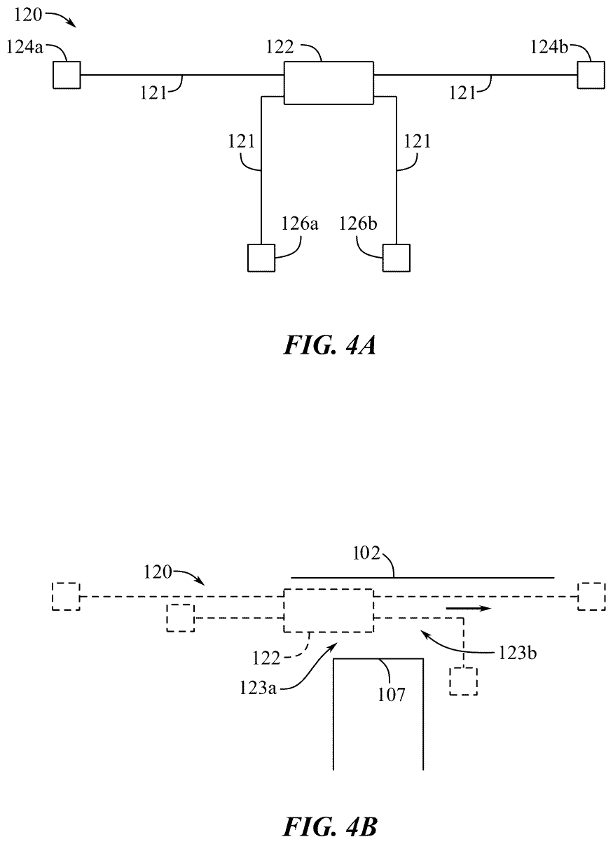

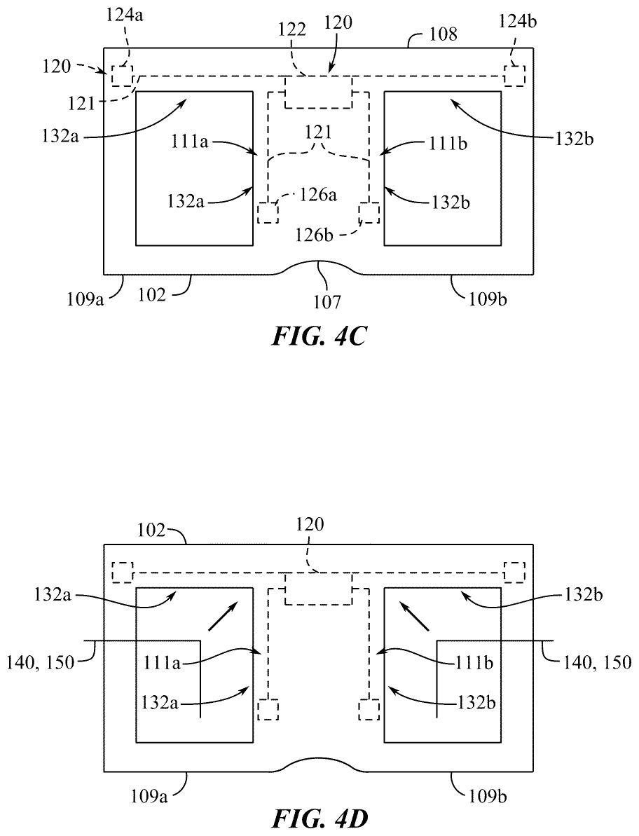

FIG. 4A-4D show an example of a process an installing the sub-assembly 120 into the frame 102 of the wearable display device 100 before the transparent windows 110a, 110b are secured within the hoops 109a, 109b of the frame 102. FIG. 4A shows a sub-assembly in which the controller 122, the first electronic components 124a, 124b, and the second electronic components 126a, 126b are electronically coupled by wires or cables 121. As discussed previously, the present disclosure is not limited to these electronic components 122, 124a, 124b, 126a, 126b and the sub-assembly 120 can include more or less electronic components.

FIG. 4B shows a detailed view of inserting the sub-assembly 120 into the frame 102. In one example, the controller 122 of the sub-assembly 120 can be slid into the bridge 107 of the frame 102. The bridge 107 of the frame 102 can define openings 123a, 123b on both lateral ends of the bridge 107 to allow the controller 122 of the sub-assembly 120 to be slid into the bridge 107. In some examples, a lower portion of the bridge 107 can be closed and in other examples the lower portion of the bridge 107 can be open.

FIG. 4C shows an example of inserting the sub-assembly 120 into the brow 108 and the hoops 109a, 109b of the frame 102. In some examples, the brow 108 and the hoops 109a, 109b define openings 132a, 132b in a direction toward the first opening and the second opening respectively, noting that the transparent windows 110a, 110b are not yet secured to the frame 102. The openings 123a, 123b of the bridge can coincide with the openings 132a, 132b. In some examples, the brow 108 and the hoops 109a, 109b are closed in a direction toward the transparent windows 110a, 110b.

Accordingly, the wires 121 that connect the controller 122 to the second electronic component 124b can be pressed or slid into the openings 132a, 132b of the brow 108 of the hoop 109b disposed above the second transparent window 110b. The wires 121 that connect the controller 122 to the first electronic component 121a can be pressed into the opening 132a or slid into the brow 108 of the hoop 109a disposed above the first transparent window 110a. The wires 121 that connect the controller 122 to the second electronic component 126b can be pressed into the opening 132b or slid into the hoop 109b adjacent to the bridge 107 and the second transparent window 110b and extend downward to an inner section 111b of the hoop 109b. The wires 121 that connect the controller 122 to the first electronic component 124a are pressed into the opening 132a or slid into the hoop 109a that is adjacent to the bridge 107 and the first transparent window 110a and extend downward an inner section 111a of the hoop 109a. In some examples, the first electronic components 124a, 124b and the second electronic components 126a, 126b are already connected to the wires 121 as they are pressed into the openings 132a, 132b or slid into place. In some examples, the first electronic components 124a, 124b and the second electronic components 126a, 126b are placed first and then the wires 121 are pressed into openings 132a, 132b or slid into place and the wires 121 are connected to the first electronic components 124a, 124b, the second electronic components 126a, 126b, and the controller 122.

FIG. 4D shows closing the sub-assembly 120 within the frame 102 of the wearable display device 100. Epoxy 140 or a cap 150, disclosed in more detail below, can be used to close the frame 102. The epoxy 140 or the cap 150 can extend a length of the brow 108 of the hoops 109a, 109b and a portion of the inner section 111a, 111b of the hoops 109a, 109b adjacent to the openings where the transparent windows 110a, 110b are installed. After the epoxy 140 or the cap 150 enclose the sub-assembly 120 within the frame 102, the transparent windows 110a, 110b can be secured to the frames 102.

Closing the sub-assembly within the frame 102 can create seams between the junction of the frame 102 and the epoxy 140 of the cap 150. The seams can be hidden from the user as they are disposed within an inner portion of the frame 102 and are hidden when the transparent frames 110a, 110b are secured to the frame 102. The hidden seams thus provide an appealing aesthetic to the user.

In this way, the channel structures, epoxy and cap sealing, and other structures described herein, can advantageously enclose various operational components and assemblies thereof within the frame 102 of the wearable display device 100 while providing an aesthetically appealing product within minimized seams and separate sections.

Any of the features, components, and/or parts, including the arrangements and configurations thereof shown in FIG. 4A-4D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4A-4D.

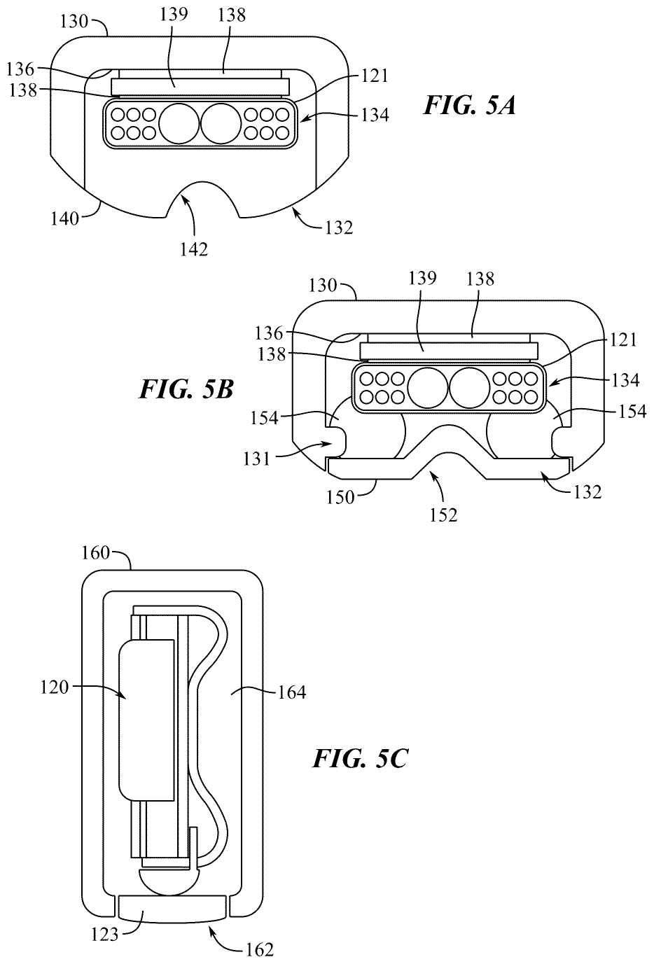

FIG. 5A shows an example of a cross-section of the brow 108 or the hoops 109a, 109b of the frame 102. In one example, the brow 108 or hoops 109a, 109b include a U-shaped portion 130. The U-shaped portion 130 can be metal, plastic, any other suitable material. In some examples, a metal U-shaped portion 130 can be thinner than a corresponding U-shaped portion 130 made from plastic. The plastic U-shaped portion 130 can be fabricated by molding, such as injection molding. The U-shaped portion 130 can include an opening 132, similar to openings 132a, 132b. The wire 121, which in the illustrated example can include a cable bundle, can extend through a cavity or slot 134 defined by the U-shaped portion 130. The cavity or slot 134 can be an internal volume of the frame 102 defined by the U-shaped portion 130. As discussed above, the wire 121 can slide through the cavity 134 or can be inserted into the cavity 134 through the opening 132. The wire 121 can be coupled to a surface 136 of the U-shape portion 130 via an adhesive 138. The illustrated example also illustrates a flex circuit 139 coupled to the surface 136 and coupled to the wires 121. After the wire 121 is secured to the surface 136 of the U-shaped portion 130, the wires 121 can be encapsulated with an epoxy 140. The epoxy 140 is configured to protect the wire 121 and electronic components from a variety of environmental factors, including moisture, dust, and physical damage.

The epoxy 140 can define a groove 142. The groove 142 can engage the transparent window 110, for example an outer perimeter edge of the transparent window 110, to secure the transparent window 110 to the frame 102. The transparent window 110 can include a bevel configured to fit within the groove 142 of the epoxy 140 to secure the transparent window 110 to the frame 102.

FIG. 5B shows an example of a cross-section of brow 108 or hoops 109a, 109b of the frame 102. Similar to the example of FIG. 5A, the brow 108 or hoops 109a, 109b includes a U-shaped portion 130 with an opening 132, similar to openings 132a, 132b. The wire 121 (illustrated as a cable bundle) extends through a cavity or slot 134 of the U-shaped portion 130. As discussed above, the wire 121 can slide through the cavity 134 of can be inserted into the cavity 134 through the opening 132 during assembly. The wire 121 can be coupled to a surface 136 of the U-shape portion 130 via an adhesive 138. The illustrated example also illustrated a flex circuit 139 coupled to the surface 136 and coupled to the wires 121. After the wire 121 is secured to the surface 136 of the U-shaped portion 130, the U-shaped portion 130 can be closed by coupling a cap 150 to shelves 131 of the U-shaped portion 130. The cap 150 can be coupled or adhered to the shelves 131 by adhesives 154. In at least one example, the cap 150 is configured to seal off the opening 132 of the cavity or slot 134 to protect the wire 121 and other electronic components from a variety of environmental factors, including moisture, dust, and physical damage.

The cap 150 can further include a groove 152. The groove 152 can be designed to secure the transparent window 110 to the frame 102. For example, the transparent window 110 can include a bevel that is designed to fit within the groove 152 of the cap 150 to secure the transparent window 110 to the frame 102.

FIG. 5C shows an example of a cross-section of the bridge 107 of the frame 102. The bridge 107 can include a U-shaped portion 160 that defines a cavity or slot 164 within the U-shaped portion 160. In at least one example, the U-shaped portion 160 includes an opening 162. A portion of the sub-assembly 120 can be disposed within the cavity 164 of the U-shaped portion 160. As discussed above, the controller 122 and potentially various other electrical components can be disposed within the cavity 164 of the U-shaped portion 160. The sub-assembly 120 can include a charging contact 123 that is configured to close the opening 162 of the bridge 107. The charging contact 123 can serve a similar function as the cap 150 of FIG. 5B. The charging contact 123 can be fixed in place by adhesives. The charging contact 123 can be configured to seal the opening 162 of the U-shaped portion and can also be configured to enable charging of a power source, such as battery 116 in the one or more securement arms 104a, 104b. In addition, the openings 123a, 123b on the lateral ends of the bridge 107 can be sealed by the same epoxy used to seal the brow 108 and the hoops 109a, 109b of the frame 102, as shown in FIGS. 5A and 5B. Accordingly, the charging contact 123 and the epoxy 140 can be configured to protect the portion of the sub-assembly 120 disposed within the cavity 164 of the bridge from a variety of environmental factors, including moisture, dust, and physical damage.

Any of the features, components, and/or parts, including the arrangements and configurations thereof shown in FIG. 5A-5C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5A-5C.

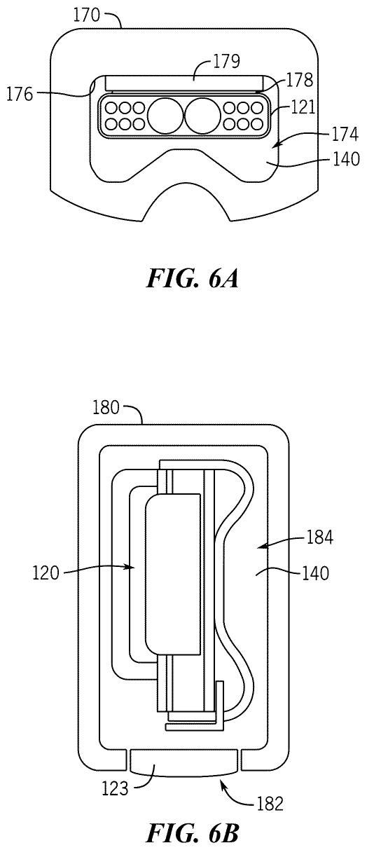

FIG. 6A shows an example of a cross-section of the brow 108 or the hoops 109a, 109b of the frame 102. In the illustrated example, the brow 108 or the hoops 109a, 109b can include a wall 170 that defines a cavity or slot 174 defining an internal volume of the frame 102. The wall 170 can be metal, plastic, or any other suitable material. The wire 121, which in the illustrated example can include a cable bundle, can extend through the cavity 174 of the wall 170. As discussed above, the wire 121 can slide through the cavity 174 during assembly. The wire 121 can be coupled to a surface 176 of the wall 170 via an adhesive 178. The illustrated example also illustrates a flex circuit 179 that is coupled to the surface 176 and coupled to the wires 121. After the wire 121 is secured to the surface 176 of the wall 170, the wires 121 can be encapsulated with an epoxy 140. The epoxy 140 can be configured to protect the wire 121 and electronic components from a variety of environmental factors, including moisture, dust, and physical damage.

FIG. 6B shows an example of a cross-section of the bridge 107 of the frame 102. In at least one example, the bridge 107 includes a U-shaped portion 180 that defines a cavity or slot 184 within the U-shaped portion 180. In at least one example, the U-shaped portion 180 includes an opening 182. A portion of the sub-assembly 120 can be disposed within the cavity 184 of the U-shaped portion 180. As discussed above, the controller 122 and other electrical components can be disposed within the cavity 184 of the U-shaped portion 180. The sub-assembly 120 can include a charging contact 123 configured to close the opening 182 of the bridge 107. The charging contact 123 can be configured to serve a similar function as the cap 150 of FIG. 5B described above. The charging contact 123 can be fixed in place by adhesives. The charging contact 123 can be configured to seal the opening 182 of the U-shaped portion and can be configured to enable charging of a power source, such as battery 116. The cavity 184 can be filled with epoxy 140. In addition, the openings on the lateral ends of the bridge 107 can be sealed by the same or a similar epoxy used to seal the brow 108 and the hoops 109a, 109b of the frame 102. Accordingly, the charging contact 123 and the epoxy 140 can be configured to protect the portion of the sub-assembly 120 disposed within the cavity 184 of the bridge 107 from a variety of environmental factors, including moisture, dust, and physical damage.

Additional options for enclosing the sub-assembly 120 within the frame 102 further include 3-D printing. For example, a portion of the frame 102 can be 3-D printed to define a cavity within the frame 102. The sub-assembly 120, including all the electronic components 122, 123, 124, 126, and the wires 121 that interconnect the sub-assembly 120, can be installed with the cavity of the frame 102. After the sub-assembly 120 is placed within the cavity, the 3-D printing can resume, thus enclosing the sub-assembly 120 within the frame 102 of the wearable display device 100.

In at least one example, using 3-D printing techniques noted above, a first portion of the frame 102 can be printed, for example a first portion of the frame such as a front portion or rear portion of the frame 102, and then the electronic sub-assemblies 120 can be disposed withing or on that first portion. Subsequent to the placement of the electronic sub-assemblies 120 into or onto the first portion of the printed frame 102, the 3-D printing of the frame 102 can continue to form the rest of the frame 102 in addition to the first portion, thus enclosing the electronic sub-assemblies 120 within the frame 102 without any visible seems. Epoxy 140, electrical contacts 123, and other fill materials or components can also be placed around the sub-assemblies 120 before the rest of the frame 102 is printed to further protect the electronic components, provide charging contacts, and dissipate heat as described herein.

In at least one example, unique surface textures can be printed using 3-D printing techniques. Surface textures can include visible patterns or texture affecting the feel of the frame 102 when grabbed or otherwise contacted by the user. 3-D printed surface textures can be used to create matte finished, high-gloss surfaces, or other surface features.

Any of the features, components, and/or parts, including the arrangements and configurations thereof shown in FIG. 6A-6B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6A-6B.

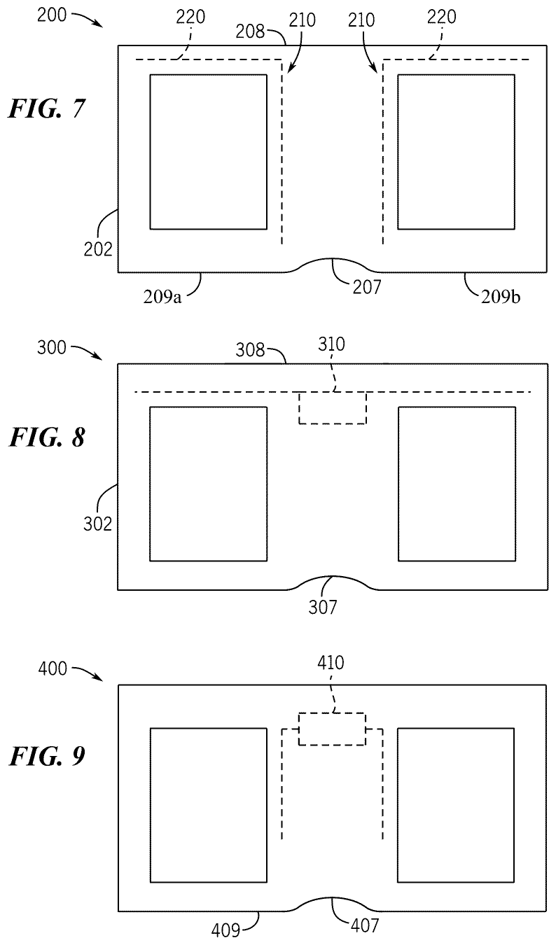

The operational electronic assemblies and sub-assemblies of the present disclosure can be disposed in various sections and portion of the frame 102. FIG. 7 shows another example of a wearable display device 200 with a sub-assembly 210. The sub-assembly 210 includes a pair of partial hoops 220 configured to be placed within a brow 208 and a hoop 209a and/or 209b of a frame 202. Each of the partial hoops 220 can include a variety of electronic components. The pair of partial hoops 220 can be installed within cavities of the brow 208 and the hoop 209a and/or 209b and can be sealed within the cavities by epoxy or a cap. In some examples, the pair of partial hoops 220 can be coupled by a wire through a bridge 207.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

FIG. 8 shows another example of a wearable display device 300 with an operational sub-assembly 310. The sub-assembly 310 can be configured to extend along an entire brow 308 and a bridge 307 of a frame 302. The sub-assembly 310 can include a variety of electronic components. The sub-assembly 310 can be installed within cavities of the bridge 307 and the brow 308 and can be sealed within the cavities by a charging contact, epoxy, or a cap.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

FIG. 9 shows another example of a wearable display device 400 with an electronic, operational sub-assembly 410. The sub-assembly 410 can be disposed within a bridge 407 and extend partially into the hoop 409 below the bridge 407. The sub-assembly 410 can include a variety of electronic components. The sub-assembly 410 can be installed within cavities of the bridge 407 and the hoop 409 and can be sealed within the cavities by at least one of a charging contact, epoxy, or a cap.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

To the extent applicable to the present technology, gathering and use of data available from various sources can be used to improve the delivery to users of invitational content or any other content that can be of interest to them. The present disclosure contemplates that in some instances, this gathered data can include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data can be used to provide insights into a user's general wellness, or can be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed. It will be apparent to one of ordinary skill in the art that many modifications and variations are possible in view of the above teachings.

What is claimed is:

1. A wearable display device, comprising:
a frame defining a first opening and a second opening;
a first transparent window disposed within the first opening and a second transparent window disposed within the second opening;
a slot defined by the frame that extends along the frame, the slot having an opening directed toward at least one of the first opening or the second opening; and
an electronic sub-assembly disposed within the slot;
wherein the slot is sealed and the electronic sub-assembly is enclosed within the slot.

2. The wearable display device of claim 1, further comprising an epoxy enclosing the electronic sub-assembly within the slot.

3. The wearable display device of claim 2, wherein the epoxy defines a groove configured to receive at least one of the first transparent window or the second transparent window.

4. The wearable display device of claim 1, further comprising a cap enclosing the electronic sub-assembly within the slot.

5. The wearable display device of claim 4, wherein the cap defines a groove configured to receive at least one of the first transparent window or the second transparent window.

6. The wearable display device of claim 1, wherein the slot extends into a bridge of the frame disposed between the first transparent window and the second transparent window.

7. The wearable display device of claim 6, wherein the electronic sub-assembly extends in the slot from a first lateral end of the frame through the bridge and to a second lateral end of the frame.

8. The wearable display device of claim 7, wherein the sub-assembly extends in the slot downward from the bridge adjacent to the first opening, and
wherein the sub-assembly extends in the slot downward from the bridge adjacent to the second opening.

9. The wearable display device of claim 6, wherein:
the bridge defines an opening on a lower portion of the bridge; and
the opening on the lower portion of the bridge is sealed with a charging contact.

10. The wearable display device of claim 1, wherein:
the wearable display device further comprises a wire; and
the sub-assembly comprises a controller electronically coupled with the electronic component via the wire.

11. The wearable display device of claim 10, wherein the electronic component comprises a least one of:
a first outward-facing camera disposed in a first temple region;
a second outward-facing camera disposed in a second temple region;
a first inward camera disposed adjacent to the first opening and a bridge, the bridge being disposed between the first opening and the second opening; or
a second inward camera disposed adjacent to the second opening and the bridge.

12. A front frame of a wearable display device, comprising:
a first hoop defining a first opening;
a second hoop defining a second opening;
a first transparent window secured in the first opening;
a second transparent window secured in the second opening;
wherein:
the first hoop defines a first slot that extends along a portion of the first opening; and
the second hoop defines a second slot that extends along a portion of the second opening; and
an electronic sub-assembly sealed within the first slot and the second slot.

13. The front frame of claim 12, further comprising a bridge disposed between the first hoop and the second hoop, wherein:
the bridge connects the first slot to the second slot; and
the electronic sub-assembly is further sealed within the bridge.

14. The front frame of claim 12, further comprising an epoxy disposed around the electronic sub-assembly and seals the first slot and the second slot.

15. The front frame of claim 12, further comprising a cap adhered to openings of the first slot and the second slot to enclose the electronic sub-assembly within the first slot and the second slot.

16. The front frame of claim 12, wherein:
the sub-assembly comprises a controller electronically coupled with an electronic component; and
the electronic component is electronically coupled to the controller via a wire bundle.

17. The front frame of claim 16, wherein the wire bundle is adhered to an internal surface of both the first slot and the second slot.

18. The front frame of claim 12, wherein:
the first slot extends along an upper section of the first hoop and downward to an inner section of the first hoop; and
the second slot extends along an upper section of the second hoop and downward to an inner section of the second hoop.

19. A front frame for a wearable display device, comprising:
a frame defining a first opening and a second opening;
a first transparent window disposed within the first opening and a second transparent window disposed within the second opening; and
an electronic sub-assembly interconnecting two or more electronic components by a wire bundle, the electronic sub-assembly entirely enclosed within the frame;
wherein:
a portion of the frame disposed above the first opening and the second opening comprises:
a U-shaped portion defining a cavity and a cavity opening directed toward at least one of the first opening or the second opening;
a wire adhered to a surface of the U-shaped portion; and
an epoxy encapsulating the wire within the cavity and sealing the cavity opening; and
the epoxy defines a groove configured to engage with at least one of the first transparent window or the second transparent window.

20. The front frame of claim 19, wherein:
the U-shaped portion is a first U-shaped portion;
the cavity is a first cavity;
the cavity opening is a first cavity opening;
the front frame further comprises a bridge at least partially disposed between the first opening and the second opening, the bridge comprising a second U-shaped portion defining a second cavity and a second cavity opening;
a controller disposed within the second cavity; and
a charging contact of the controller disposed within the second cavity opening.
